(19) United States
(12) Patent Application Publication
(10) Pub. No.: US 2005/0228821 A1
(43) Pub. Date: Oct. 13, 2005

(54) Stand-alone system for storing books in electronic memory

(76) Inventor: Charles D. Gold, Seattle, WA (US)

Correspondence Address: JENSEN + PUNTIGAM, P.S., SUITE 1020, 2033 6TH AVE, SEATTLE, WA, 98121, US

(21) Appl. No.: 11/150,516

(22) Filed: Jun. 9, 2005

Related U.S. Application Data
(63) Continuation-in-part of application No. 11/091,792, filed on Mar. 28, 2005.
(60) Provisional application No. 60/556,606, filed on Mar. 26, 2004.
(60) Provisional application No. 60/556,743, filed on Mar. 26, 2004.
(60) Provisional application No. 60/578,699, filed on Jun. 10, 2004.
(60) Provisional application No. 60/587,225, filed on Jul. 10, 2004.
(60) Provisional application No. 60/605,407, filed on Aug. 27, 2004.
(60) Provisional application No. 60/604,634, filed on Aug. 25, 2004.
(60) Provisional application No. 60/579,021, filed on Jun. 10, 2004.

(51) Int. Cl. G06F 17/30

(52) U.S. Cl. 707/102

(57) ABSTRACT

The system includes a memory card, such as flash memory, containing information which would otherwise be published in conventional book form, such as a textbook, wherein the information on the card is in read-only form and further includes security elements, which prevent unauthorized access to the book content in the card. The system also includes a display device for receiving the memory card, reading the information in the memory card and displaying the information, wherein the display device is a stand-alone system, incapable of being connected to a network or other system so as to prevent transfer or copying of information from the display device. The system further includes a vending machine for dispensing the memory cards in response to a selection by the customer/user, the memory cards including security elements.

### PRIOR APPLICATION

This is a continuation-in-part application of pending U.S. patent application Ser. No. 11/091,792 filed Mar. 28, 2005.

### CROSS-REFERENCE TO RELATED APPLICATIONS

This application claims the priority of the following U.S. provisional applications: Ser. No. 60/556,606 filed Mar. 26, 2004, titled “Listing Software for Color Highlighting, Underlining and/or Marking of Electronic Texts in Electronic Devices”; Ser. No. 60/556,743 filed Mar. 26, 2004, titled “Business Model for Distribution of Textbooks on Portable Electronic Devices”; Ser. No. 60/578,699 filed Jun. 10, 2004, titled, “Use of Externally Attached Security Means on Electronic Memory Cards”; Ser. No. 60/587,225 filed Jul. 10, 2004, titled “Portable Electronic Reading and/or Displaying Device for Electronic Memory Cards with RFID System for Enhanced Security”; Ser. No. 60/605,407 filed Aug. 27, 2004, titled “RFID Interrogator in or on Electronic Memory Cards”; and Ser. No. 60/604,634 filed Aug. 25, 2004, titled “Recognition of RFID Signal by Electronic Memory Cards”. This application also claims the priority of provisional application Ser. No. 60/579,021, filed Jun. 10, 2004, titled “Vending Machine For Electronic Memory Cards With Labeling, Packaging And/Or Security Coding”.

### TECHNICAL FIELD

This invention relates generally to information display systems and more particularly concerns a dispensing system for an information storage element portion of a combination of an information storage element and a display device for the information, including a dispensing device for the storage elements.

### BACKGROUND OF THE INVENTION

Historically, printed books have been a primary means for conveying information to users. This includes textbooks, which are used in schools and other educational institutions, but also includes books for pleasure reading as well. It is quite common for users of books to transport them in various ways, including briefcases, backpacks and book bags, among others. Such transporting of books is often cumbersome and inconvenient, however, and particularly in the case of students, who must carry a large number of books to and from school or between classes, physical strain and even injury can easily occur.

Typically, the solution to the above problem of book transport, particularly for students, has involved various means for carrying the books in a more convenient manner. These attempts include various hand carry devices, or various backpack arrangements, noted briefly above. Such articles, however, provide only minimal help in carrying books, as they do not address the fundamental issue of carrying a large number of heavy books/textbooks. The difficulty of carrying books is not as severe typically when books are being carried for pleasure reading since typically only a few such books are carried at a particular time. Yet even in those cases, the issue of bulk and weight of the book becomes a limiting factor. Constant carrying of books also results in wear and tear on the books as they are constantly lifted and often knocked about during carrying and use.

Electronic books are also known. These have some advantages over conventional books and may also have additional features, including recall, dictionary and search capability, among others. Electronic books can be delivered over the internet (World Wide Web). However electronic books and internet delivery systems present significant issues for book publishers, including copyright infringement/piracy and interruption of their traditional distribution process.

Hence, it would be desirable to have a system for conveniently carrying books, including textbooks, without the cumbersome nature of and inconvenience of conventional books, and at the same time avoiding piracy and other possible disadvantages of electronic books.

### SUMMARY OF THE INVENTION

Accordingly, the present invention is a vending machine system for dispensing memory cards with book content, comprising: a plurality of memory cards having pre-installed book content thereon or adapted to have book content installed thereon within the vending machine system; a selection assembly permitting a customer to select a particular book which includes book content available from the vending machine system; and a dispensing system responding to the customer's selection for providing to the customer a memory card with the selected book content installed thereon.

### BRIEF DESCRIPTION OF THE DRAWINGS

FIG. 1 is a schematic view showing the basic system of the present invention.

FIGS. 2A-2D are schematic views showing selected security features of the present system.

FIG. 3 is a schematic view showing a particular aspect of the present system.

FIG. 4 is a schematic view showing another aspect of the present system.

FIG. 5 is a schematic view showing yet another aspect of the system of the present invention.

FIG. 6 is a schematic view showing a vending machine system for memory elements.

### BEST MODE FOR CARRYING OUT THE INVENTION

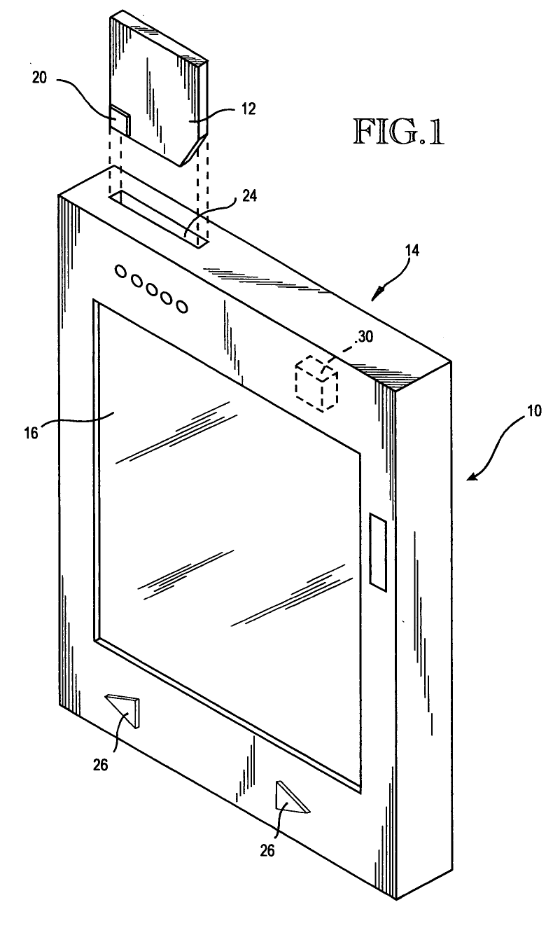

Referring to FIG. 1, the present system 10 includes a small electronic memory card 12 such as “flash memory”, on which is stored the information, including text and illustrations, usually contained in a conventional book, for instance a textbook. The system further includes a display device 14 which includes a display screen 16 of a selected size. This system 10 allows the convenient transport of a large number of books in a convenient carrying case (not shown) or other means of transport. The carrying case can for instance include one large pocket or receptacle for carrying the display device 14 and a plurality of smaller pockets for carrying the individual memory cards, each of which contains a part of or a complete textbook or other book. The display device may be secured by Velcro or other attachment means. The carrying case can also include a space or pocket for a notebook for use in making notes about the book, class notes or the like. This system 10 eliminates the physical strain and inconvenience of carrying around a large number of separate books which are in many cases even individually quite heavy.

The electronic memory card 12 is a conventional electronic data storage element such as for instance a compact flash memory card, or other similar card or device. Various small memory elements can be used. They should be reasonably rugged. The memory devices are quite small, compact and lightweight, usually less than one ounce, and are otherwise suitable for being conveniently stored in a carrying case. The book material stored on the memory card would typically be the information comprising a conventional printed book such as a text book. This can include text as well as illustrations and/or photographs present in the book.

Typically, the information will be stored in a read only format, thereby providing security from either being accessed, modified, copied or transferred to another device from which the material could be either viewed, copied or transmitted further without the permission of the owner of the copyright on the material. The memory card 12 can also include conventional anti-theft/tampering software 20 which will disable the use of the card or information on the card if tampering is detected. The memory card may also include various security features, which are discussed in more detail below.

The display system 14 as indicated above includes a screen 16 which can be of various sizes. The display could be a touch screen, liquid crystal display, LED display or other electronic display. Display system 14 is not capable of being connected to any transmission device or external network or other device, including internet, telephone or other network, to insure the security of the material on the memory card and to prevent the material being displayed from being copied or otherwise disseminated in any way. The display device includes no electronic data input or output capability to prevent any communication of data to or from the device. The display device also includes a capability of disabling itself, temporarily or permanently, if it is tampered with such as by attempting to open its case.

The display device is capable of displaying the information on the memory card upon insertion of the card into the display system entry port 24, or with other action of the user, such as a switch. The display device includes a conventional processor with software 30 which processes (reads) the information stored in coded form on the electronic memory card 12 and then displays it in human recognizable form on the display screen 16. Forward and reverse “page turning” reading controls 26 as well as other display controls, such as contrast, brightness, text quality and size etc.) permit the user to move through the material at a desired speed (forward or back) or manage various image factors. The controls can further include fast forward and rewind, if desired, to increase the speed of the scanning of the text. In addition, further controls can be provided to immediately locate a particular portion of the text, for instance a selected chapter in a multi-chapter book. The controls can be in the form of buttons or other finger generated controls. An electronic menu for function control is also possible.

The display device 14 may also include an anti-tampering feature in its software 30 as well as a verification capability for an inserted memory card carried out prior to the information therein being read and displayed. This verification system could include for instance, a coded signal transmitted from the display device 14 to the inserted memory card 12 or vice versa, to initiate the processing and display of the memory card.

One significant feature of the present system includes a software capability of highlighting text on the electronic display with selected colors and a marking element, using a touch screen and an electronic or other type of stylus. The software capability to highlight and/or underline or otherwise mark a section of text in an electronic display generally is known in other digital information formats and hence is not described in detail here. However, the ability to highlight particular portions of the displayed text is a significant feature of the combination system involving a memory card containing a book, such as a textbook, and a stand alone reader/display device. The marked material may be transferred to another element in the display device but cannot be transmitted out of the device.

The user can electronically mark parts of the text or illustrations which the user is reading or studying. Different colors can be used. Remarks or notes can be added to the margins if desired, although this is not necessary to the basic system Further, the software has the ability to recall the marked or highlighted parts in a list form sorted for instance by color or other criteria. For instance all of text highlighted in yellow could be displayed together. Some or all of the information in the lists could include the chapter number, chapter title, page number or other identifying information for each highlighted portion in the list.

Searching of the full text or just the highlighted information can be done and the results listed on the basis of key words, in addition to colors. The listing ability in the present system permits grouping of information without having to create a new electronic document. The display of a particular list can be accomplished by the user with a simple manually implemented command to the device identifying the particular desired list. One example could be simply holding down the button which activated the particular desired highlighting function for a pre-selected period of time, e.g. longer than 3 seconds. The basic concept involves a two step software controlled process, in which the text is first electronically marked in some fashion, either by highlighting or underlining by the user, with the user then selecting a particular list identified by a button or other manually-operated member, in accordance with selected list criteria. Again, highlighting of material electronically is generally known but not as part of software controlling the display in the present combination system.

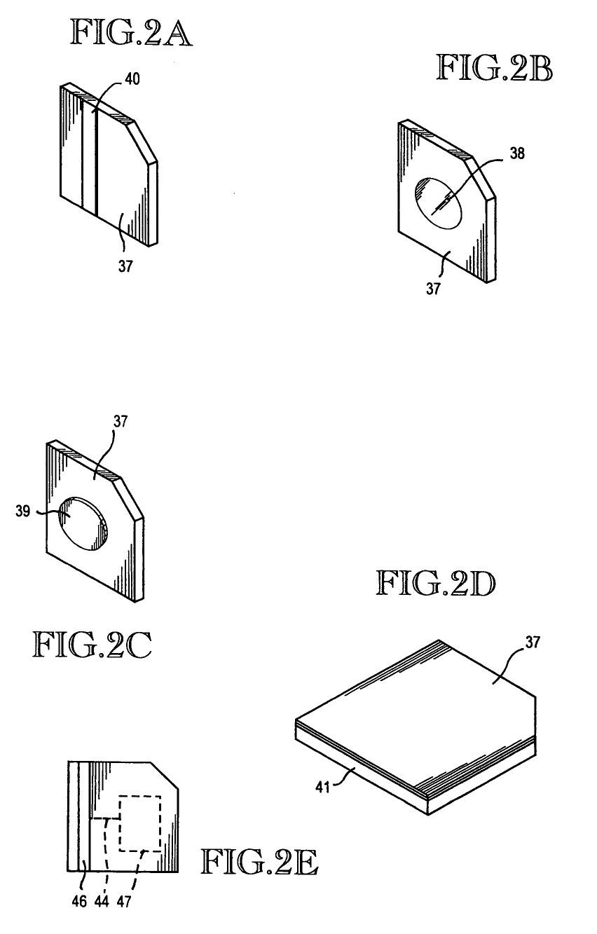

Another aspect of the present system includes a security element or elements which may be placed on the memory card 12. The security element typically is added to the memory card before the content although it may be an integral part of the card when manufactured, and provided with security instructions before, during or after the time when the book content is provided on the card. The external security may include an RFID (radio frequency identification) means which is discussed in more detail below, as well as other magnetic, optical, or electronic security means. This can be done in the form of a label or tag, strip or spot on the card 37. This is shown for instance at 38 in FIG. 2B which is a spot or at 39 in FIG. 2C or can be in the form of a magnetic strip 40 as shown in FIG. 2A. The external security element can be separated from the surface of the electronic memory card by an insulating barrier 41, if desired, to prevent signal interference between the memory card and the security element. The security element could also be electrically connected to the internal electronic circuits of the memory card, if desired, so that it can cause some action in the memory card, including an on-off function to enable the display of the content of the memory element, with or without going through the processor in the display device.

The display device 14 will have the ability to recognize the security element present on the memory card. If the device finds the security information provided back by the security element acceptable, access to the content on the memory card by the device is then permitted. This assures for instance that a particular memory card is accessible only by a specific display device, if such a function is desired. If, for instance, a memory card with a particular type of security element is inserted into a display device which is not authorized to display that memory card, the display device would be unable to recognize the signal from the security element and would not be able to open the book information present on the memory card for display.

The security element can be positioned on the memory cards in various locations; for instance, it could be placed relatively near the bottom of the card so that verification of the card can be accomplished before contact is made with the stored information. It is also possible that the security element could be positioned so that the verification could occur at any point following insertion of the memory card.

As discussed briefly above, a security element 46 on a memory card could be connected via an electrical link 44 to the memory circuits 47 in the card. In this embodiment, a signal from the display device could be generated upon verification of the electronic card, the signal being applied to the electronic circuits in the card over the electrical link. The information on the card is only accessible to the display device if the signal from the security element is received.

Also, as briefly indicated above, the security element could have the capability of responding to an attempt to tamper with the security element or the electronic memory card itself or to an unauthorized attempt to access the content of the memory card by either permanently disabling or temporarily scrambling the information on the memory card.

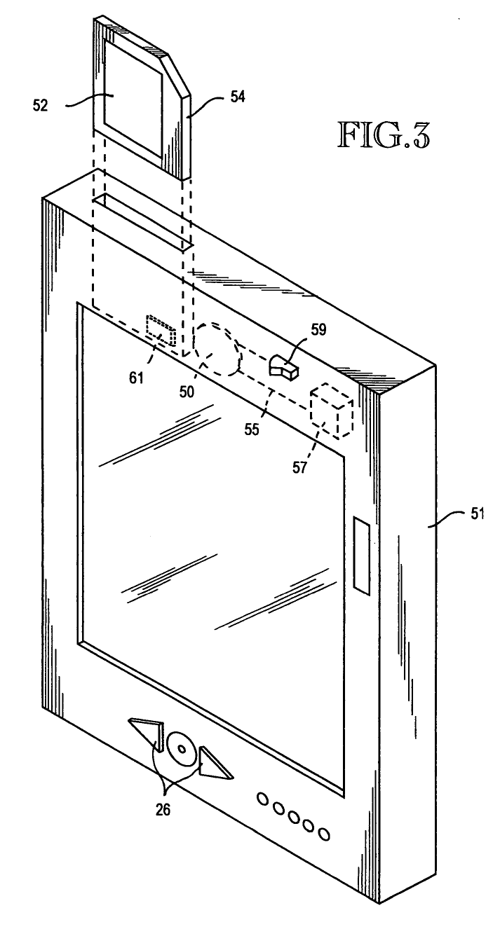

An additional or alternate security means can be used to provide further security to the system. This additional security uses RFID (radio frequency identification) capability. It is possible that a conventional security element discussed above as well as encryption methods may not provide adequate security to protect uncontrolled and undesired access to the information on the memory card. Such conventional security strategies can often be defeated electronically or by other means. RFID can provide an additional level of security to that discussed above or may be sufficient by itself. In this arrangement, referring to FIG. 3, a RFID system includes an interrogator member/reader 50, sometimes also referred to as a base station, in or on the display device 51, and an RFID label or tag 52 attached to or incorporated in memory card 54, with an electrical connection 55 between the RFID reader and the display device processor 57. The RFID system may obtain its power from the display device or it may have its own separate power source.

The RFID interrogator reader may be operated by a control switch 59 to activate its operation only when an electronic memory card 54 is inserted into the display device 51, or activation of the system could be accomplished by physical contact between the inserted memory card and a contact element 61 in the receptacle for the card in the display device. A timer could also be used at the RFID interrogator reader to automatically turn power off to the RFID device after a period of time long enough for communication to occur between the reader and the tag on the memory card.

The RFID label 52 contains information which is communicated to the RFID reader following receipt of the interrogator signal. The RFID system increases the reliability of the overall security of the system. The RFID reader 50 in the display device determines, following communication from the RFID label, that the memory card carrying the interrogated RFID label is approved for use in the display device and consequent display of the contents on the card. The RFID label may, in addition, contain accumulated information about previous access attempts and times thereof, all of which can be ascertained by the reader in the display device.

If the RFID reader 50 determines that from the information received back from the RFID label 52 that the memory card contents may be displayed, RFID reader 50 will signal the memory card to open all or part of its stored contents to the display device. This can be done with a signal from the RFID reader 50 or the display device 51 itself can provide a trigger signal to the memory card.

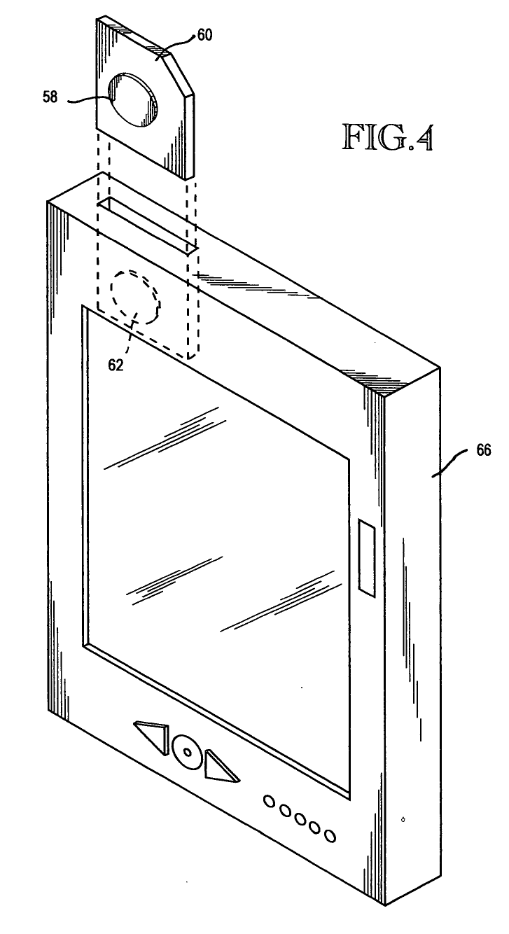

Alternatively, referring to FIG. 4, a surface mounted (or internal) RFID interrogator/reader 58 can be positioned on electronic memory card 60 with an RFID tag or label 62 in the display device 66. The interrogator/reader 58 verifies that the display device 66 is authorized to read and display the contents of the particular memory card inserted in the display device. Typically, there will be an electrical connection between the interrogator/reader 58 on the memory card and the memory circuits on the card to allow the electronic memory card to be used in the display device. Hence, the interrogator/reader on the card can provide a signal to the display device to permit processing and display of the information on the card by the display device or the interrogator/reader can provide a signal to the electronic circuits on the card permitting access to the contents thereof by the display device. As another alternative, both the memory card and the display device could have RFID interrogator/-readers, a “double” interrogator/reader arrangement.

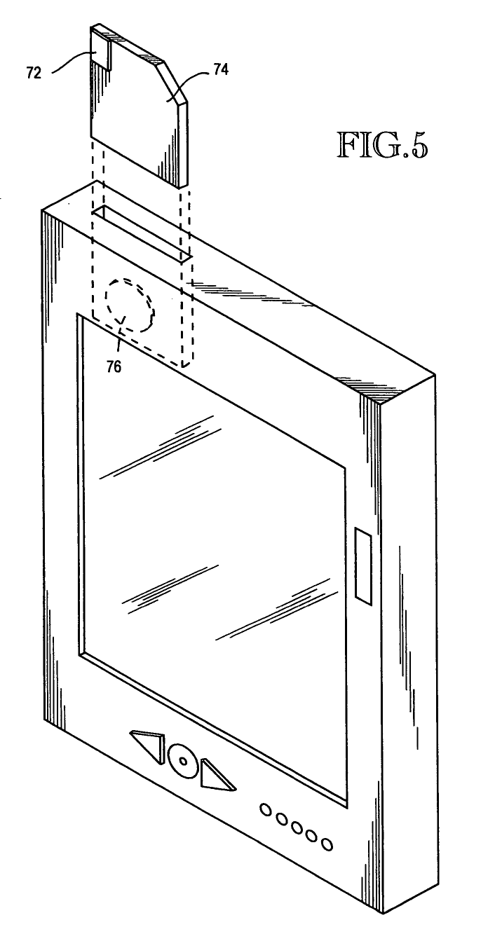

As an additional feature of an RFID system, referring to FIG. 5, individual electronic memory cards 70 may include a system 72, in addition to an RFID label or in the absence thereof, for determining that the card has been interrogated by an RFID interrogator/reader 76. The detection capability can work separately or in conjunction with the normal function of the RFID identification label. The system 70 could be capable of detecting an RFID inquiry at a particular frequency or frequencies or at all frequencies. This detection system could include an antenna, which recognizes an RFID transmission or other material that responds to an RF (radio frequency) transmission by physical expansion or other change of state to activate a switch in the electronic circuits on the memory card. The system 70, upon detection of the RFID inquiry will increment the previous number of inquiries made to it and can then further trigger a response in the memory card, for instance, disabling the card upon an unauthorized or incorrect RFID inquiry or enabling the RFID inquiry to be completed following a selected time beyond an authorized RFID inquiry. A system 70 could also be used on a memory card without an RFID element to permit access to its content when receipt of an RFID interrogation signal is recognized. The RFID inquiry triggers a response in the memory card, such as an electronic on-off switch or other sequence, for access to the contents stored on the card. The memory card could have means to use the energy from the RFID interrogator to produce the desired response/function in the card. Hence an RFID security capability can be obtained in the absence of an RFID element on the memory card. This particular RFID arrangement for a memory card can be used in system other than the display system disclosed herein.

Hence, a system has been disclosed for convenient storage of book information, including particularly textbooks, on a small, lightweight, easy to carry electronic memory card. The contents of the memory card can be processed and displayed as well as marked by the user in the form of a software controlled display device. The system can include various security controls, including various RFID systems.

The above-described system is adapted for use particularly with students attending a school. A package or kit is provided by the school or other authorized entity to the student. The combination package/kit includes the display device, textbooks for a particular class or classes on flash memory cards or similar high density storage media and a carrying case which is enhanced with pockets or containers to carry the display device and the memory cards for convenient access. A notebook can also be included. The school or other organization can make the package/kit available to the students or to parents on behalf of the students for purchase or lease.

A feature of this method is that while textbooks per se are eliminated, the normal economic marketing chain of textbook providers is not interrupted, apart from the contribution of the printing industry, since the owners of the copyright on the text will be still in a position to provide the textbooks, albeit in a different form, to the schools. Copyright rights are protected under this system. The distribution method will include the security protections discussed above with respect to both the memory and the display device, to prevent unauthorized copying or transmission of the material on the memory cards, and if desired, provide security protection to ensure that only authorized memory cards and authorized display devices are used in the system.

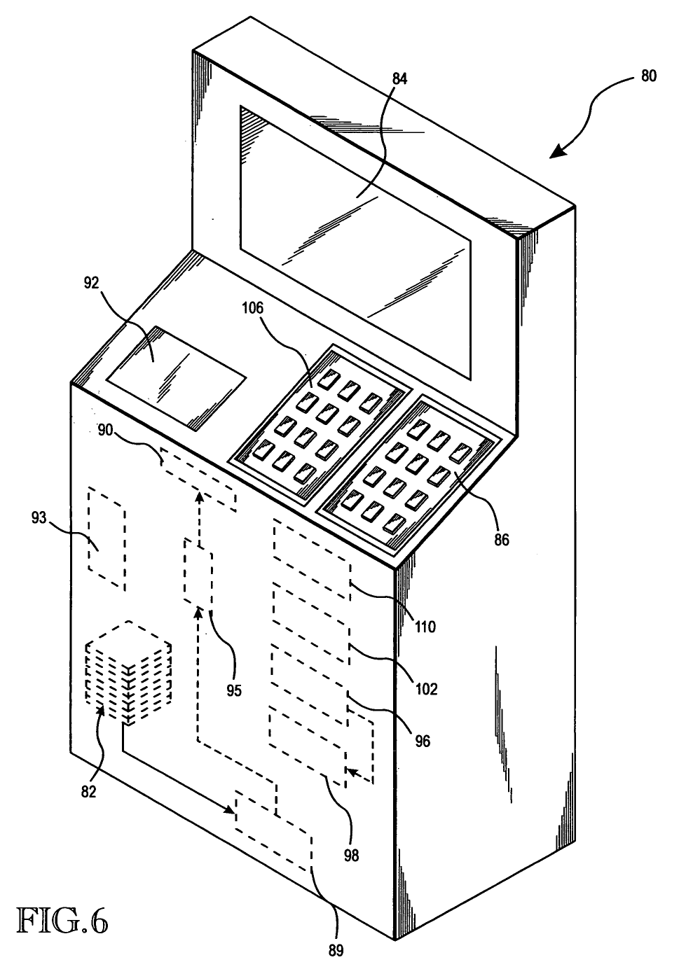

A vending machine, shown in FIG. 6, can be used in dispensing the memory cards with the book content described above. The vending machine 80 can dispense memory cards of various configurations and arrangements, including flash memory cards, secure digital cards, compact flash digital cards, smart media cards or other similar storage media. The vending machine has stored within it a plurality of individual such memory cards 82. The cards are adapted to be used in selected display devices, in which they may be displayed, read and/or interacted with by the user, as discussed in detail above. The memory cards 82 may be limited in use, such as to particular viewing devices, or not, as desired. The individual memory cards 82 may have book content preinstalled on them, or the book content may be installed on the memory cards 82 within the vending machine by a system 89 in response to a selection by a customer. Further, the selected book content may be obtained from a remote source.

The vending machine 80 has a display 84 which lists the book titles available through the machine, and a selection keyboard or similar arrangement 86 may be used to select the desired book or books. In addition, or alternatively, the display 84 may include a touch screen portion/capability, by which a selection may be made. Further selection may be made remotely through a terminal, either in the vicinity of the vending machine 80, or off-site.

Following the selection of the desired book or books by the customer, the vending machine will retrieve the selected preinstalled memory card from its supply or will install the desired book onto a memory card from its own storage of books or remotely obtained.

The desired memory card/cards will be dispensed to the customer by means of a vending apparatus 95 well known in the art through an outlet 90. Payment for the memory card with book content can be made through various receiving means, shown generally at 92, by a credit card, with cash, a payment verification or other form of payment.

The vending machine has the capability of communicating with third party entities concerning the authorization or verification of payment. The machine includes a record-keeping system 93, which records the transactions and produces a receipt for the customer's and/or the seller's benefit. The system also maintains an on-going inventory of the number and title of books sold and remaining pre-installed memory cards available, if such preinstalled memory cards are available through the machine.

In addition, the vending machine can include a labeling system 96. The labeling system includes the capability of printing a label which is either affixed to the memory card in some manner or applied directly to a surface of the memory card. The machine could also print directly onto the memory card or on a label previously secured to the memory card. The labeling system is capable of producing a label which is similar to actual book covers. The labeling system could also be used to print a bar code for inventory or other identification purposes on the memory cards.

In addition, the vending machine has the capability of packaging the memory card or cards, generally at 98, with either plastic or paper. The labeling system 96 discussed above has the capability of printing labels on the packaging as well.

The vending machine 80 has the further capability of installing/placing security information in the form of a code or other implementation onto the dispensed electronic memory cards 82. The security system 102 can have various functions. In one arrangement, the security system 102 could use a code such that the memory card is only accessible for reading, etc. by a selected reading device, as discussed in detail above. The security coding applied to the card by the security system 102 could also control the use of the electronic memory card, such as permitting its use for only a selected amount of time, or limiting the number of uses. The system also has the capability of using security codes applicable to a selected one of a number of possible accessing devices, in response to a customer identifying the selected device through a selection assembly 106 or in response to the customer using a card having identification information thereon, or by scanning the selected device or a label thereon.

Further, the vending machine has a capability of installing additional external security/identification information by means of system 110. The security information provided by system 110 can be positioned on the memory card or the packaging. The security/identification information can be in the form of a code. Such external security is discussed above in detail. The external security is recognizable by an authorized access device for reading, etc.. The security elements can include, as discussed above, RFID interrogators and tags, EAS (electronic article surveillance) tags, magnetic, optical and/or barcode elements, or an electronic strip or spot, or other similar external security elements. All of these enhance the overall security of the content installed on the memory card. The system 110 can encode security elements and install them on the card or can encode blank security elements already installed on the card.

The security elements can also function as a verification that the electronic memory cards dispensed by the machine have been purchased legitimately as the customer exits a store with the goods.

The vending machine thus has the capability of providing secure, convenient access by a customer at various retail locations to memory cards having book content installed thereon.

Although a preferred embodiment of the system disclosed herein has been disclosed for purposes of illustration, it should be understood that various changes, modifications or substitution may be incorporated in the embodiment without departing from the spirit of the invention which is defined by the claims which follow.

1. A vending machine system for dispensing memory cards with book content, comprising:
a plurality of memory cards having pre-installed book content thereon or adapted to have book content installed thereon within the vending machine system, the memory cards being adapted for use in a customer's reading device;
a selection assembly permitting a customer to select a particular book comprising book content available from the vending machine system; and
a dispensing system responding to the customer's selection for providing to the customer a memory card with the selected book content installed thereon.

2. The system of claim 1, including a system for accepting payment for the memory cards to be dispensed, maintaining a record of transactions with the customer, and generating a receipt to the customer for said transaction.

3. The system of claim 1, including an assembly for printing a label used with the memory card dispensed, the label providing information concerning the book content on the memory cards.

4. The system of claim 3, wherein the label is affixed to the memory card.

5. The system of claim 3, wherein the label is printed on the memory card.

6. The system of claim 3, wherein the label has an appearance similar to a book cover.

7. The system of claim 1, including a packaging assembly for packaging the memory cards therein prior to being dispensed.

8. The system of claim 7, including an assembly for printing a label containing book information and attaching it onto the packaging.

9. The system of claim 1, including a system for installing a first security coding along with the book content on the memory card or on an element on the memory card which restricts access to the book content to an authorized device.

10. The system of claim 9, wherein the first security coding provides preselected restrictions on use of the memory card.

11. The system of claim 9, wherein the first security coding installed on the card is associated with a device selected by a customer or identified by other input information.

12. The system of claim 10, wherein the first security coding defines the time during which the memory card may be used by the access device and/or the number of uses of the memory card.

13. The system of claim 1, including a system for attaching or placing external security elements on the memory card for protecting the memory card against unauthorized use, the security elements comprising one or more of the following: RFID tag, EAS tag, magnetic, optical, bar code, electronic strip or spot.

14. The system of claim 13, including means for encoding the security elements with security information or identification information.

15. The system of claim 1, including means for encoding external security elements present on the memory cards for protecting the memory card against unauthorized use, the security elements comprising one or more of the following: RFID tag, EAS tag, magnetic, optical, bar code, electronic strip or spot.

16. The system of claim 1, wherein the selection assembly includes at least one remote station for selecting a particular book available from the vending machine system.

17. The system of claim 1, wherein the system includes a book content retrieval system for obtaining book content from a remote source.
